(19) United States
(12) Patent Application Publication
(10) Pub. No.: US 2012/0288130 A1
(43) Pub. Date: Nov. 15, 2012

(54) Microphone Arrangement

(75) Inventor: Alfons Dehe, Reutlingen (DE)

(73) Assignee: Infineon Technologies AG, Neubiberg (DE)

(21) Appl. No.: 13/105,105

(22) Filed: May 11, 2011

(51) Int. Cl. H04R 1/20; H04R 31/00; H04R 1/02

(52) U.S. Cl. 381/353; 381/361; 29/594

(57) ABSTRACT

A microphone arrangement includes a housing having a sound hole, a first input audio transducer with a first sensitivity and a second input audio transducer with a second sensitivity. In this microphone arrangement, the first and the second input audio transducers are arranged in the housing, such that the first input audio transducer is directly acoustically coupled with the sound hole and the second input audio transducer is indirectly acoustically coupled with a sound hole via the first input audio transducer.

### TECHNICAL FIELD

Embodiments according to the invention relate to a microphone arrangement and a method for manufacturing a microphone arrangement.

### BACKGROUND

Audio recording with a mobile device, for example, a mobile phone, poses different demands on the device's microphone for different application cases. In case of a call, the microphone has to ensure a good Signal-to-Noise-Ratio (SNR), approximately 60 dB(A), for a low Sound Pressure Level (SPL), approximately 60 to 70 dBSPL, with a low Total Harmonic Distortion (THD less than 1%). The second exemplary application case is audio-visual camcording of a distant acoustic source, for example, a speaking person captured at a distance of a few meters. For this exemplary application case, a high Signal-to-Noise-Ratio, e.g., more than 66 dB(A), would be advantageous. A third exemplary application case is audio-visual camcording, but in this case with very high sound pressure levels (e.g., more than 120 dBSPL up to 140 dBSPL) which are present, for example, at a rock concert. For this exemplary application case, audio distortion should be avoided by the microphone as much as possible (THD less than 10%).

For mobile devices, miniaturized microphones or micro-electro-mechanical-systems (MEMS) are used as loudspeakers or microphones, wherein digital microphones are problematic due to the associated analogue digital converter having a limited dynamic range. Thus, a microphone with a high sensitivity enables high signal-to-noise-ratio, but in the case of high sound pressure levels, it causes high total harmonic distortions. On the other hand, a microphone with a low sensitivity has a too low signal-to-noise-ratio for moderate sound pressure levels.

### SUMMARY OF THE INVENTION

Some embodiments according to the invention provide a microphone arrangement comprising a housing having a sound hole, a first input audio transducer with a first sensitivity and a second input audio transducer with a second sensitivity. The first input audio transducer is arranged in the housing such that the same is directly acoustically coupled with the sound hole. The second input audio transducer is encased in the housing, such that the same is indirectly acoustically coupled with the sound hole via the first input audio transducer.

A further embodiment provides a microphone arrangement comprising a housing having a sound hole, a first input audio transducer and a second input audio transducer. The first and the second input audio transducer are arranged in the housing, such that the first input audio transducer is directly acoustically coupled with the sound hole and the second input audio transducer is indirectly acoustically coupled with the sound hole via the first input audio transducer. The embodiment further comprises a sound-damping element, which is arranged in the housing for damping a sound signal propagating to the second input audio transducer.

A method for manufacturing a microphone arrangement according to embodiments disclosed herein comprises providing a housing having a sound hole. A first input audio transducer is arranged with a first sensitivity in a manner, such that the first input audio transducer is directly acoustically coupled with the sound hole. A second input audio transducer is arranged with a second sensitivity in such a manner, such that the second input audio transducer is indirectly acoustically coupled with the sound hole via the first input audio transducer.

### BRIEF DESCRIPTION OF THE DRAWINGS

FIG. 1a shows a schematic cross-sectional view of a microphone arrangement according to an embodiment;

FIG. 1b shows a schematic cross-sectional view of a microphone arrangement according to another embodiment;

FIG. 2a shows a schematic top view of a microphone arrangement according to a further embodiment;

FIG. 2b shows a schematic cross-sectional view of the microphone arrangement of FIG. 2a;

FIG. 3a shows a schematic top view of a microphone arrangement comprising an electronic circuitry, in accordance with a further embodiment;

FIG. 3b shows a schematic cross-sectional view of the microphone arrangement of FIG. 3a;

FIG. 4 shows a schematic block diagram of a microphone arrangement comprising an electronic circuitry, in accordance with a further embodiment; and

FIG. 5a-5l show different schematic top views and cross-sectional views of a sensor chip and an electronic circuitry of the microphone arrangement during the manufacturing process according to a further embodiment.

### DETAILED DESCRIPTION OF ILLUSTRATIVE EMBODIMENTS

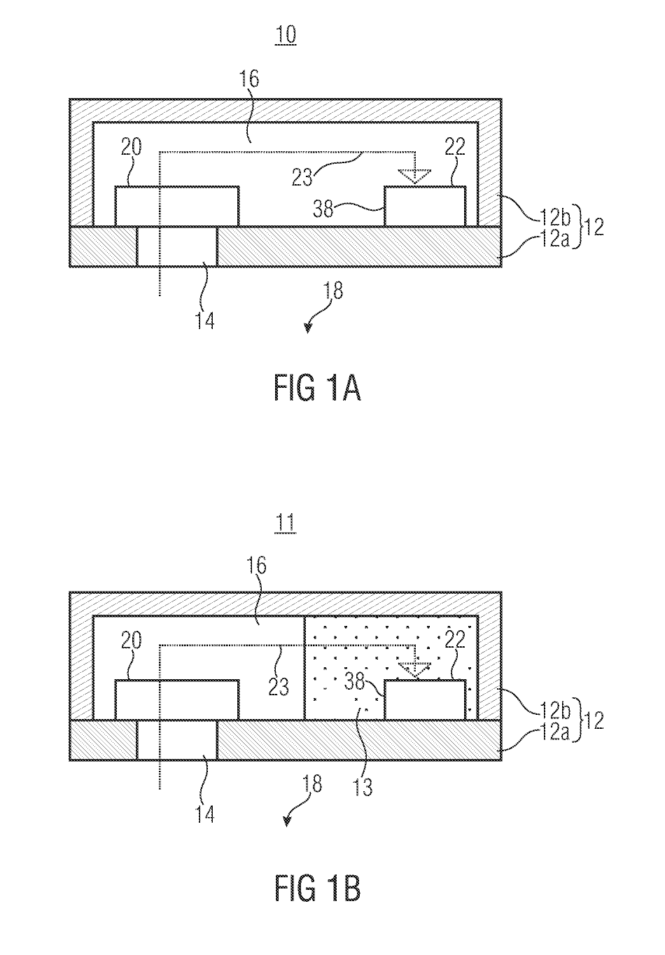

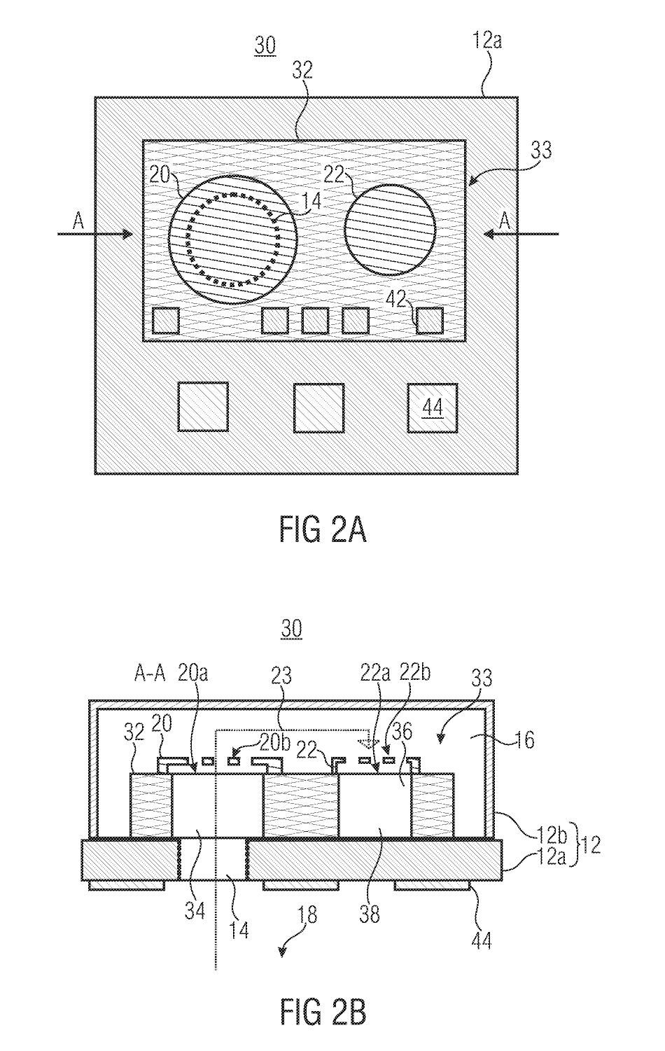

Different embodiments of the teachings disclosed herein will subsequently be discussed referring to FIGS. 1 to 5, wherein in the drawings identical reference numerals are provided to objects having an identical or a similar function so that objects referred to by identical reference numerals within the different embodiments are interchangeable and the description thereof is mutually applicable.

FIG. 1a shows a microphone arrangement 10 according to a first embodiment. The microphone arrangement 10 comprises a housing 12 having different wall elements, such as a ground plate 12a and a top cover 12b fixed thereon. By means of the wall element, an inner volume or space 16 is formed within the housing 12. A sound hole or sound opening 14 extends through one of the wall elements of the housing 12. Here, the sound hole 14 is exemplary formed in the ground plate 12a.

Furthermore, the microphone arrangement 10 comprises a first input audio transducer 20 with a first sensitivity, which is formed on the ground plate 12a, e.g., aligned with the sound hole 14 so that the sound hole 14 is covered by the first transducer 20. Further, the microphone arrangement 10 comprises a second input audio transducer 22 with a second sensitivity within the housing 12. The second transducer 22 may be also arranged on the ground plate 12a, but in a lateral offset position with respect to first transducer 20. Alternatively, the second transducer 22 may be principally placed at any position on one of the wall elements within the housing. In this exemplary embodiment, a MEMS element may be respectively used as the first and second transducer 20 and 22, which usually comprises, as active sensor structures, a membrane and a counter-electrode, not shown in FIG. 1a. A so-called back-volume is associated to each transducer, wherein the inner volume 16 forms the back-volume for the first transducer 20, and wherein the back-volume 38 of the second transducer 22 is defined between the ground plate 12a and an active sensor area of the second transducer 22.

In the following, the function of the microphone arrangement 10 will be discussed in detail.

The first transducer 20 is arranged in the housing 12 such that same is directly acoustically coupled with the sound hole 14. Here, the sound hole 14 provides a sound channel from an external space 18 (not shown), e.g., from an external sound source, to the first transducer 20, and via same to the internal volume 16 inside of the housing 12. The second transducer 22 is arranged in the housing 12 such that the same is, for example, directly acoustically coupled with the internal volume 16 and is indirectly acoustically coupled with the sound hole 14 and the external space 18 via the first transducer 20. In other words, the arrangement defines a sound propagation path 23 for an acoustic signal from the external space 18, via the sound hole 14 and the first transducer 20, through the internal volume 16 to the second transducer 22.

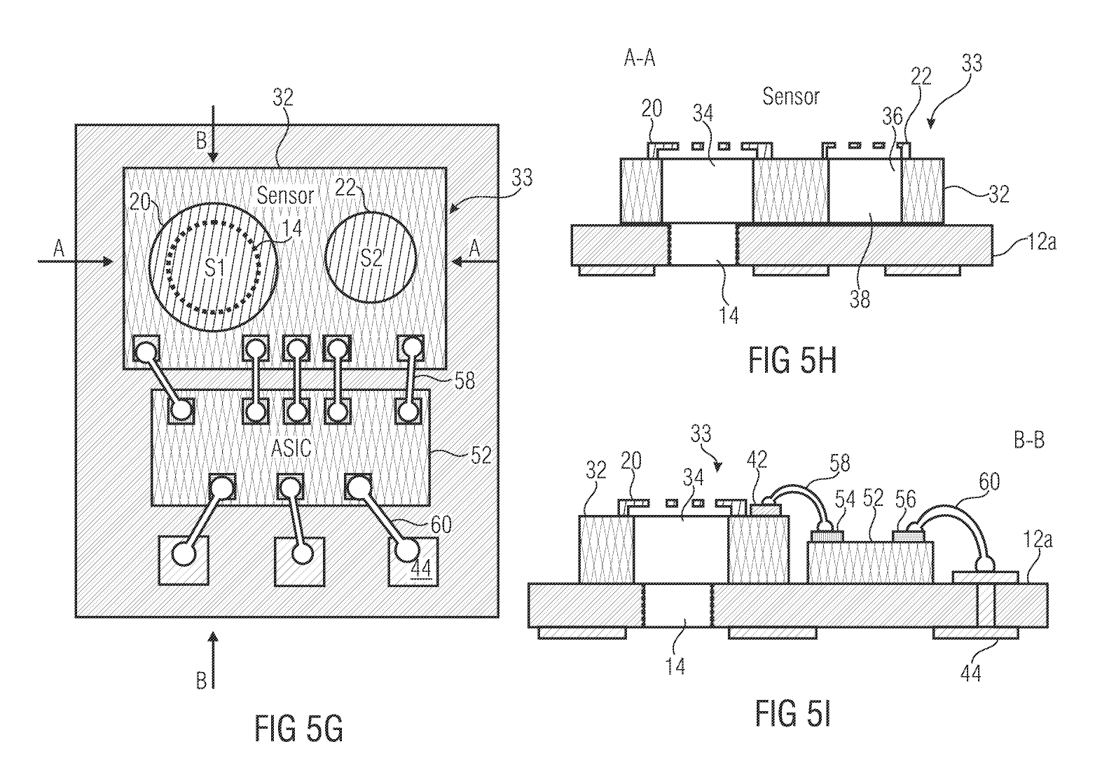

The first and second transducers 20 and 22 are configured to transduce an acoustic signal, i.e., the proportion of the acoustic signal arriving at the respective transducer, from the external space 18 into first and second electrical audio signals, respectively. For example, the first transducer 20 has a relatively high sensitivity and is dimensioned for moderate sound pressure levels, such as, for example, 70 to 90 dB or 60 to 120 dB, and is optimized, for example, for a high signal-to-noise-ratio compared to the second transducer 22. The second transducer 22 has a lower sensitivity than the first transducer 20 and is optimized for high sound pressure levels, such as, for example, 120 to 140 dB or 100 to 145 dB, together with a lower signal-to-noise-ratio in comparison to the first transducer 20. The two transducers 20 and 22 may output their electrical audio signals to an electronic circuitry, as described in the following with respect to FIG. 4.

The sensitivity difference of the first and second transducers 20 and 22 may be based on different configurations (e.g., of the active sensor areas) of the first and second transducers 20 and 22, on different back-volumes 16 and 38, an additional damping element associated to the respective transducer for damping the acoustic signal at the propagation path 23 or a combination of the above sensitivity adjusting factors.

To be more specific, the different sensitivities of the two transducers 20 and 22 may be caused by different diameters or different material properties of the membranes (i.e., of the active sensor structures of the two transducers 20 and 22). For example, the diameter of the membrane of the second transducer 22 may be smaller than the diameter of the membrane of the first transducer 20 in order to reduce the sensitivity of the second transducer 22 relative to the sensitivity of the first transducer 20. The lower sensitivity of the second transducer 22 could also be a consequence of an increased thickness of the membrane and/or a reduced flexibility of the membrane of the second transducer 22 compared to the membrane of the first transducer 20. A modification of the electrical properties such as, for example, the capacity between the membrane and the counter-electrode, is another alternative for modifying the sensitivity of the two transducers 20 and 22 relative to each other. Increasing or reducing the gap between the membrane and the counter-electrode of the transducers can provide a modification of the capacity. In order to reduce the sensitivity of the second transducer 22, the gap between its membrane and its counter-electrode could be increased, for example.

In this embodiment the effective sensitivity difference between the two transducers 20 and 22 is based also on the specific arrangement of the two transducers 20 and 22 within the housing 12. The indirect coupling of the second transducer 22 results in an acoustic damping (attenuation) of an acoustic signal propagated from the external space 18 via the first transducer 20 to the second transducer 22 (see sound propagation path).

The sizes of the back-volumes 38 and 16, respectively, have an additional impact on the effective sensitivity of the two transducers 20 and 22. A smaller back-volume of one of the transducer 20 or 22 usually increases the mechanical damping of the membrane and, thus, reduces a transducer's effective sensitivity. Therefore, in the microphone arrangement 10, the first transducer 20 has the back-volume 16 and the second transducer 22 has the back-volume 38, which is smaller than the back-volume 16 in order to desensitize the second transducer 22 relative to the effective sensitivity of the first transducer 20.

Alternatively, the microphone arrangement may comprise further transducers, for example, a third and fourth transducer for further sensitivity ranges, within the housing 12.

FIG. 1b shows a microphone arrangement 11, which is similar to the embodiment 10 of FIG. 1a, but further comprises a sound-damping element 13 in the propagation path 23 of a sound signal, in comparison to the microphone arrangement 10 of FIG. 1a.

The sound damping may be realized by the additional sound-damping element 13, for example, a foam material, etc., at least partially in the propagation path 23 in the internal volume 16, which partially absorbs acoustic signals propagating to the second transducer 22.

Therefore, it would be possible to use, for example, two identical input audio transducers 20 and 22 having the same sensitivity, wherein the effective sensitivity of the second transducer 22 is reduced by using a sound damping element 13 in the signal propagation path. Such an embodiment could give an additional cost advantage due to a simplified fabrication process. As a consequence, the position of a sound damping element in the propagation path allows the utilization of any (equal or different) pair of transducers, if the different effective sensitivity is adjusted by means of the sound damping element.

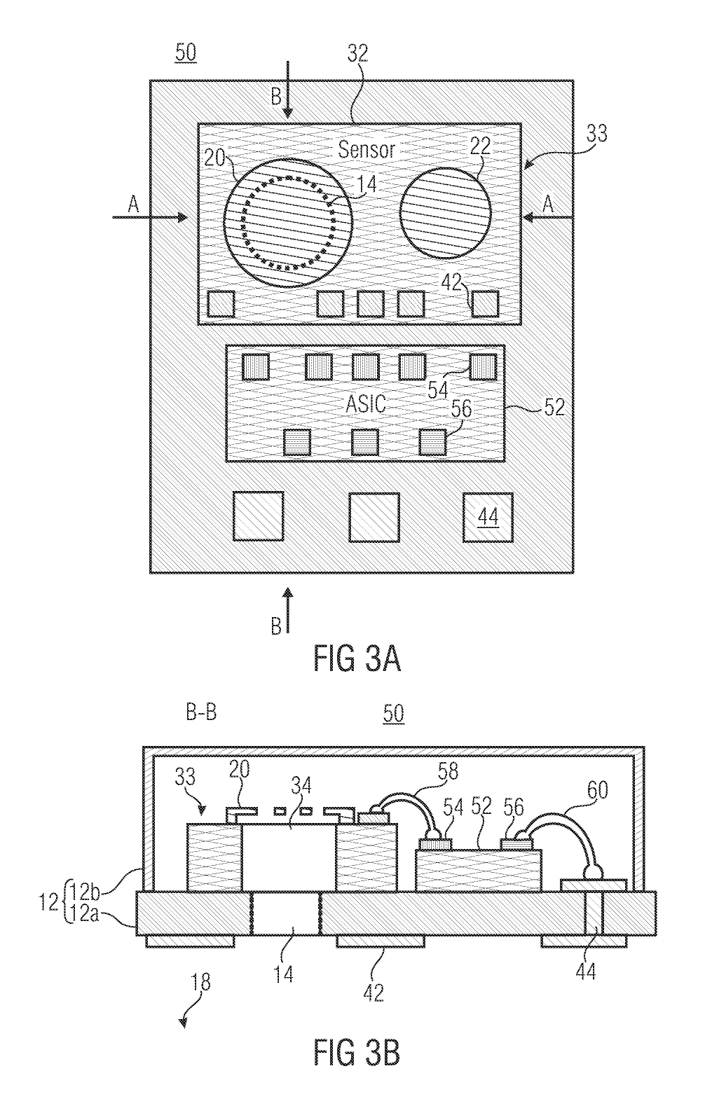

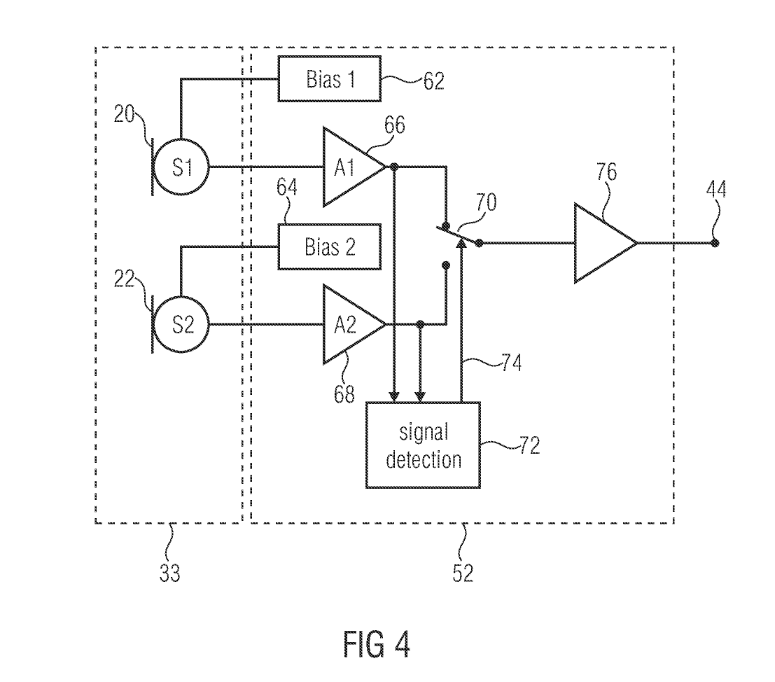

Below, a microphone arrangement 30 will be described with respect to FIGS. 2a and 2b. FIGS. 2a and 2b show the microphone arrangement 30 further comprising, in comparison to the microphone arrangement 10, a common substrate 32. The first transducer 20 and second transducer 22 are provided, for example, on same the substrate 32, wherein membranes 20a and 22a are built on a surface of the substrate 32. Facing the membranes 20a and 22a, the counter-electrodes 20b and 22b are mounted above the surface. In the following, the substrate 32 having the two transducers 20 and 22 formed thereon is also designated as a sensor chip 33. The substrate 32 has a first hole 34 aligned with the first transducer 20 and a second hole 36 aligned with the second transducer 22. The substrate 32 is formed on the ground plate 12a of the housing 12 which is closed by the top cover 12b, as shown in FIG. 1a. The sound hole 14 of the ground plate 12a, which may comprise an acoustically permeable foam as a mechanical protection element, is aligned to the hole 34 and thus, to the first transducer 20. Analogously to FIG. 1a, the internal volume 16 of the housing 12 defines the back-volume 16 of the first transducer 20. The hole 36 aligned with the second transducer 22, defines the back-volume 38, along with the membrane 22a of the second transducer 22 and the ground plate 12a closing the hole 36 on the opposite side.

In the embodiment of FIGS. 2a and 2b, contacts 42 are arranged on the substrate 32. Contacts 44, which are also designated as output pads 44, are platted through the ground plate 12a. Via these contacts 42 and 44 the two transducers 20 and 22 may be electronically connected to an electronic circuitry 52 (not shown), as described below in FIG. 4.

In the following, the function of the microphone arrangement 30 will be discussed in detail.

In the microphone arrangement 30, the two transducers 20 and 22 are arranged in the housing 12 such that the first transducer 20 is directly acoustically coupled with a sound hole 14 via the hole 34, while the second transducer 22 is indirectly acoustically coupled with the sound hole 14 via the first transducer 20 and the hole 34. Analogously to FIG. 1a, the sound hole 14, the hole 34, the first transducer 20 and the internal volume 16 define the propagation path 23 to the second transducer 22. As a result of this, the first transducer 20 is arranged to receive the acoustic signal from the external space 18, e.g., from an acoustic source, directly, and the second transducer 22 is arranged to receive the acoustic signal from the external volume in a pre-damped manner, namely pre-damped by the first transducer 20, as described above.

Alternatively to the above embodiments, the substrate 32 can be a part of the housing 12 in place of the ground plate 12a.

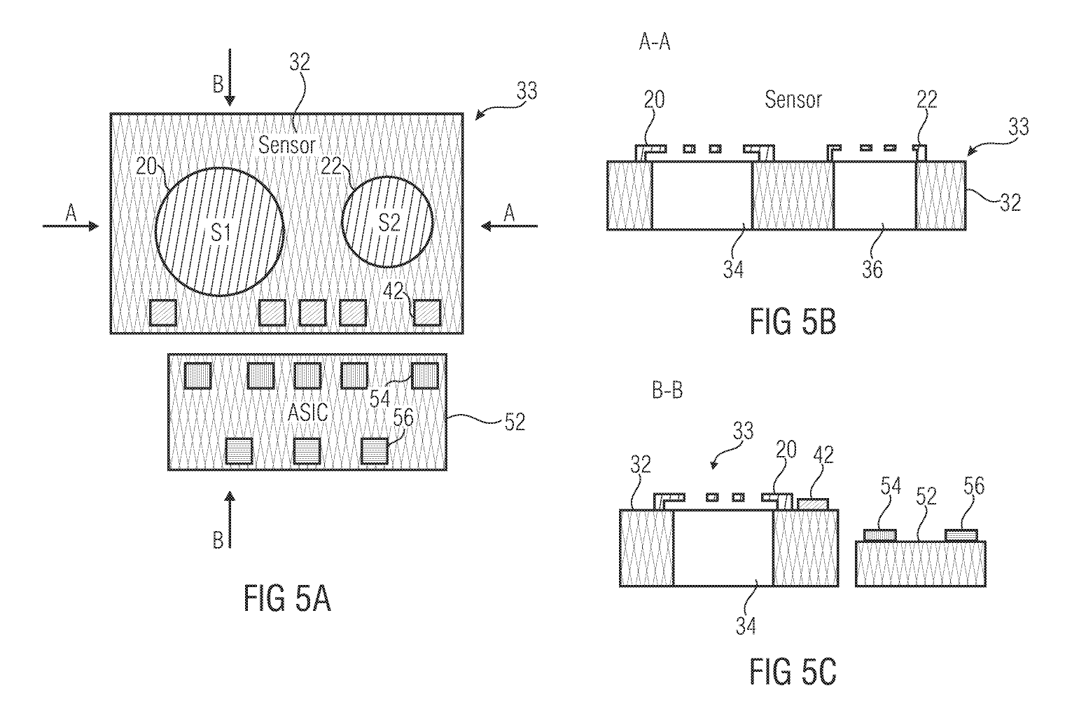

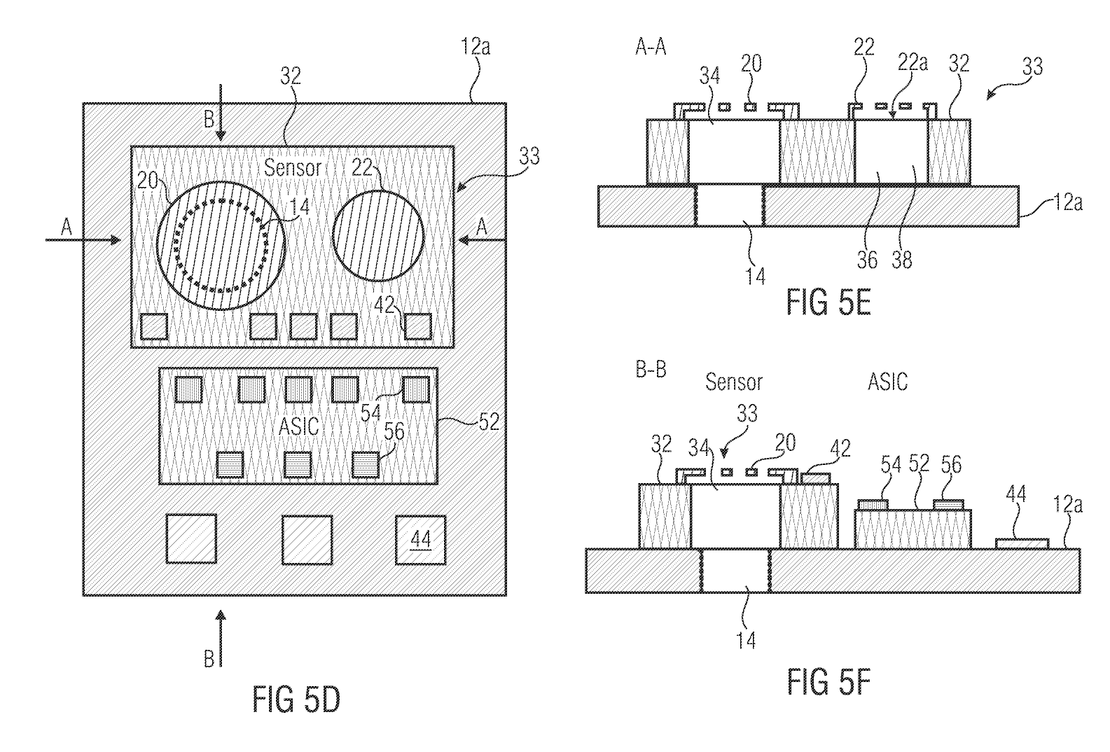

Below, a microphone arrangement 50 will be described by FIGS. 3a and 3b. FIGS. 3a and 3b show a microphone arrangement 50, which complies with microphone arrangement 30 of FIGS. 2a and 2b, but further comprises an electronic circuitry 52, e.g., an application specific integrated circuit (ASIC), arranged in the housing 12.

The microphone arrangement 50 comprises the first transducer 20 and the second transducer 22 built on the substrate 32, as shown in the embodiment of FIGS. 2a and 2b. The substrate 32 having the two transducers, is implemented here as a sensor chip 33, and is formed on the ground plate 12a of the housing 12, analogously to the embodiment of FIGS. 2a and 2b. Therefore, the cross-sectional view (A-A) through the sensor chip 33 of the microphone arrangement 50 is equivalent to the cross-sectional view (A-A) of the sensor chip 33 of the microphone arrangement 30 shown in FIG. 2b.

The electronic circuitry 52, which is formed on the ground plate 12a, has contacts 54 to connect the electronic circuitry 52 with sensor chip 33 via the contacts 42. The electronic circuitry 52 is provided with additional contacts 56 to connect same with the output pads 44. In this embodiment, the connection between the sensor chip 33 and the electronic circuit 52 is exemplary realized by wire-bonding 58 between the contacts 42 and the contacts 54. The connection between the electronic circuit 52 and the contacts 44 is realized by wire-bonding 60 between the contacts 56 and the contacts 44. The contacts 44 are plated through the ground plate 12a of the housing 12 in order to be able to output an electronic audio signal from the microphone arrangement 50 to a mobile device in which the microphone arrangement 50 may be built in.

The functionality of the sensor chip 33 complies with functionality of the microphone arrangement 30. The structure and the functionality of electronic circuitry 52 will be described in FIG. 4. The electronic circuitry 52 may be built in form of an application specific integrated circuit (ASIC).

Alternatively to the above discussion, the electronic circuitry 52 may be formed on the same substrate 32 on which the two transducers 20 and 22 are built. An alternative would be to use the substrate 32 in place of the ground plate 12a as a part of the housing 12, wherein the microphone arrangement 50 is closed by the top cover 12b fixed to the substrate 32.

A further alternative would be that the sensor chip 33 and/or the electronic circuitry 52 are separated into singular subunits which are arranged within the housing 12.

Alternatively the sensor chip 33 and electronic circuit 52 may be electrically connected by another connection type, for example, in a flip-chip-manner.

FIG. 4 shows the electronic circuitry 52 and the sensor chip 33 in accordance with an embodiment. The sensor chip 33 comprises the first transducer 20 and the second transducer 22. The electronic circuitry 52 includes a first bias supply 62 connected to the first transducer 20 and a second bias supply 64 connected to the second transducer 22. The electronic circuitry 52 includes a switch 70, which is connected to the first transducer 20 via an amplification stage 66 and to the second transducer 22 via an amplification stage 68. A second amplification stage 76 is placed between the switch 70 and the output pads 44. The electronic circuitry 52 contains a signal detector 72, which is connected to the amplification stage 66 and the amplification stage 68. The signal detector 72 is configured to control the switch 70 via a control signal 74 and is, for that reason, connected with the switch 70.

The first and second bias supply 62 and 64 define the bias point of the two transducers 20 and 22, for example, by applying a DC voltage onto the membrane 20a and the counter-electrode 20b and the membrane 22a and the counter-electrode 22b, respectively. The two transducers 20 and 22 are configured to receive acoustic signals and to transduce these signals into electrical audio signals passing through the amplification stages 66 and 68, respectively. The signal detector 72 analyzes the characteristics of the electrical audio signals regarding the sound pressure levels, signal to noise ratio and total harmonic distortion. On the basis of this analysis, the switching between the electrical audio signals from the two transducers is performed by the switch 70 controlled by the control signal 74 in order to output the electrical audio signal, which is more suitable for the current application case. The electrical audio signal of one of the two transducers passes the second amplification stage 76 and is output via the output pads 44.

Alternatively, the mobile device may control, via the control signal 74, the switch 70. Furthermore, this electronic circuitry 52 or parts of this electronic circuitry 52 can be integrated into the mobile device or can be implemented by a computer software executable by the electronic circuitry 52 or by a combination of a computer software and an electronic circuitry 52.

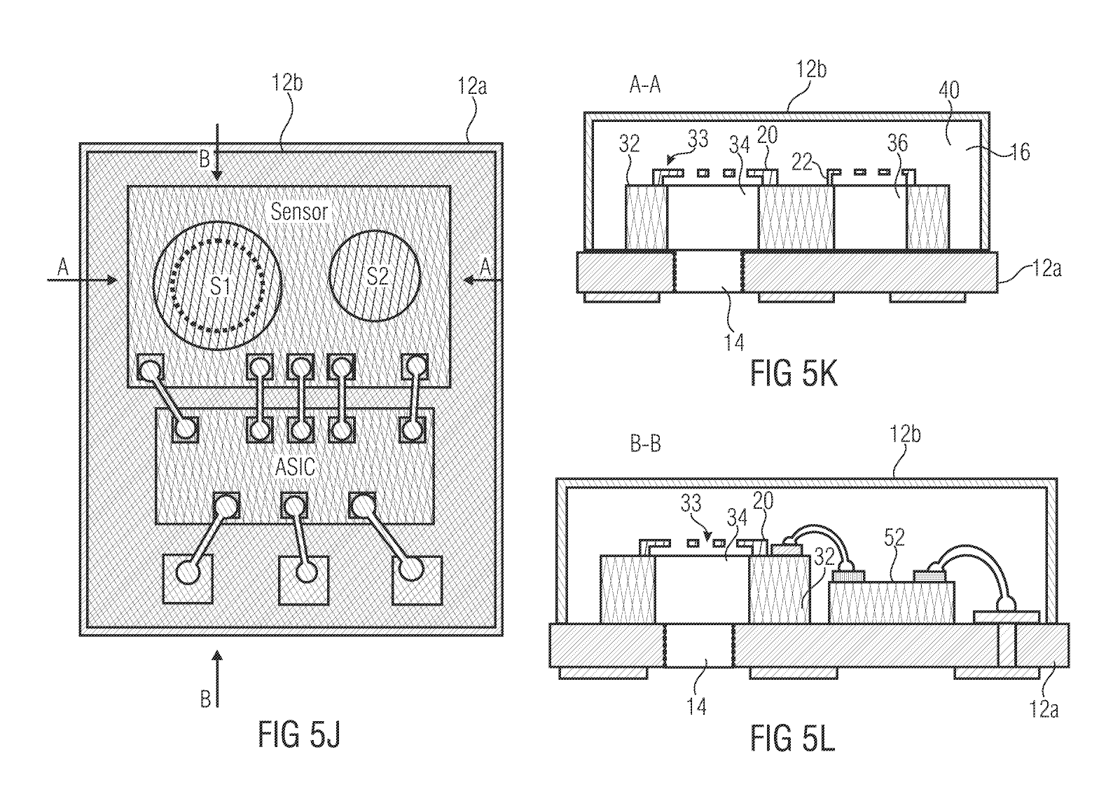

FIGS. 5a-5l show different schematic top views and cross-sectional views of a sensor chip and an electronic circuitry of the microphone arrangement during the manufacturing process according to a further embodiment.

Below, FIGS. 5a to 5c illustrate an early step of the manufacturing process. FIGS. 5a to 5c show the electronic circuitry 52 (ASIC) and the sensor chips 33, after the first and second transducer 20 and 22 have been built on the substrate 32. Before forming the two transducers 20 and 22, the substrate 32 is provided with the two holes, 34 aligned with the first transducer 20, and 36 aligned with the second transducer 22 as well as with conducting paths (not shown) for connecting the two transducers 20 and 22 to the contacts 42. At this stage of the manufacturing process, the contacts 54 for the purpose of connecting the sensor chip 33 are already provided on the electronic circuitry 52 as well as the contacts 56 on same for the purpose of connecting the output pads 44.

During this step of the manufacturing process the electronic circuitry 52 and the sensor chip 33 are being arranged for the next step of the manufacturing process side by side.

The step of the manufacturing process subsequent to the step shown in FIGS. 5a to 5c is illustrated in FIGS. 5d to 5f, which show the electronic circuitry 52, the sensor chip 33 and the ground plate 12a.

During this step of the manufacturing process, the sensor chip 33 and the electronic circuitry 52 are being mounted on the ground plate 12a. The sensor chip 33 is being arranged on the ground plate such that the acoustic hole 14 of the ground plate 12a is aligned with the hole 34 and thus with the first transducer 20. Therefore, the sensor chip 33 is being provided on the ground plate 12a with a first side facing to a second side of the substrate 32 where the two transducers 20 and 22 are built and where the contacts 42 are provided. Furthermore, the sensor chip 33 is being provided on the ground plate 12a so that the hole 36 of the substrate 32 is being closed by the ground plate 12a for defining the back-volume 38, as described in FIGS. 2a and 2b. The electronic circuitry 52 is being provided on the ground plate 12a next to the sensor chip 33 with a first side facing to a second side of the electronic circuitry 52 where the contacts 54 and 56 are provided. The sensor chip 33 and the electronic circuitry 52 may be fixed on the ground plate 12a, for example, by solder, glue or a tight fit.

Below, the wire-bonding step of the manufacturing process is illustrated by FIGS. 5g to 5i, which show the electronic circuitry 52, the sensor chip 33, the ground plate 12a and wire-bonding 58 and 60.

During this step of the manufacturing process, subsequent to the step shown in FIGS. 5d to 5f, the sensor chip 33 and the electronic circuitry 52 are being electronically contacted. At this, the sensor chip 33 is being connected to the electronic circuit 52 by the wire-bonding 58 and the electronic circuit 52 is being connected to the output pads 44 by the wire-bonding 60. The wire-bonding 58 between the contacts 42 and 54 and the wire-bonding 60 between the contacts 56 and 44 may be realized, for example, by soldering or conductive adherence. During this step, the continuous bonding of the contacts 44 through the ground plate 12a is being done, too.

The microphone arrangement 50 resulting from the manufacturing process is illustrated in the FIGS. 5j to 51. The arrangement 50 complies with the arrangement shown in FIGS. 3a and 3b.

During this step of the manufacturing process the sound damping element 13 (not shown) may be placed in the housing 12 for setting the sensitivity of the first and the second transducer 20 and 22 such that the first sensitivity of the first transducer 20 is different to or higher than the second sensitivity of the second transducer 22. This is an optional step of the manufacturing process before the housing 12 of the microphone arrangement 50 is being closed, if, for example, two transducers 20 and 22 with the same sensitivity have been built on the substrate 32 and, thus, the sensitivity difference between the two transducers 20 and 22 is set by the sound damping element 13.

During this last step of the manufacturing process, the microphone arrangement 50 is being closed by the top cover 12b fixed on the ground plate 12a. The top cover 12b may be fixed by glue or solder on the ground plate 12a so that the internal volume 16 and the back-volume 38, respectively, are being built.

Alternatively, the chronological order of the singular steps of the steps of the production process may vary and also singular steps may be modified.

What is claimed is:

1. A microphone arrangement comprising:
a housing having a sound hole; and
a first input audio transducer with a first sensitivity and a second input audio transducer with a second sensitivity;
wherein the first and the second input audio transducers are arranged in the housing such that the first input audio transducer is directly acoustically coupled with the sound hole and the second input audio transducer is indirectly acoustically coupled with the sound hole via the first input audio transducer.

2. The microphone arrangement as in claim 1, wherein the first sensitivity is different than the second sensitivity.

3. The microphone arrangement as in claim 2, wherein the first sensitivity is higher than the second sensitivity.

4. The microphone arrangement as in claim 1, wherein the first sensitivity is equal to the second sensitivity.

5. The microphone arrangement as in claim 1, wherein the first and the second input audio transducers are formed on a substrate having a hole aligned with the first input audio transducer such that the first input audio transducer is directly acoustically coupled with the sound hole via the hole of the substrate.

6. The microphone arrangement as in claim 5, wherein the housing comprises a ground plate and a top cover fixed to the ground plate, wherein the ground plate is formed by the substrate.

7. The microphone arrangement as in claim 5, wherein the first input audio transducer has a first back-volume and the second input audio transducer has a second back-volume.

8. The microphone arrangement as in claim 7, wherein the first back-volume is different than the second back-volume.

9. The microphone arrangement as in claim 8, wherein the first back-volume is larger than the second back-volume.

10. The microphone arrangement as in claim 7, wherein the first back-volume is defined by an inner space of the housing.

11. The microphone arrangement as in claim 7, wherein the second back-volume is defined by a second hole through the substrate, the second hole being aligned with the second input audio transducer.

12. The microphone arrangement as in claim 1, further comprising a sound damping element arranged in the housing for damping a sound signal propagating to the second input audio transducer.

13. The microphone arrangement as in claim 1, further comprising electronic circuitry arranged in the housing, wherein the electronic circuitry is configured to receive a first electrical audio signal from the first input audio transducer and a second electrical audio signal from the second input audio transducer and is configured to switch between the first and second electrical audio signals depending on characteristics of the first and second electrical audio signals.

14. The microphone arrangement as in claim 13, wherein the electronic circuitry and the first and second input audio transducers are formed on a common substrate.

15. A method for manufacturing a microphone arrangement, the method comprising:
providing a housing having a sound hole;
arranging a first input audio transducer with a first sensitivity in the housing such that the first input audio transducer is directly acoustically coupled with the sound hole; and
arranging a second input audio transducer with a second sensitivity in the housing such that the second input audio transducer is indirectly acoustically coupled with the sound hole via the first input audio transducer.

16. The method as in claim 15, further comprising:
setting the second sensitivity by placing a sound damping element in a sound propagation path to the second input audio transducer such that the first sensitivity is higher than the second sensitivity.
